(19) United States
(12) Patent Application Publication
(10) Pub. No.: US 2025/0172858 A1
(43) Pub. Date: May 29, 2025

(54) MONITORING CAMERA AND ASSOCIATED MOUNTING METHOD

(71) Applicant: Faurecia Clarion Electronics Europe, Paris (FR)

(72) Inventors: Sébastien BARBARAT, Paris (FR); Roudhouane BELKHIRI, Paris (FR); David DA SILVA, Paris (FR)

(21) Appl. No.: 18/964,210

(22) Filed: Nov. 29, 2024

(30) Foreign Application Priority Data
Nov. 29, 2023 (FR) FR 2313244

(51) Int. Cl. G03B 17/56; G03B 15/03; H04N 23/51; H04N 23/52

(52) U.S. Cl. CPC G03B 17/561; G03B 15/03; H04N 23/51; H04N 23/52

(57) ABSTRACT

A monitoring camera that includes: an optical sensor; a light source; first and second printed circuit boards, attached to the optical sensor and the light source respectively; a first electrical device, attached to the first printed circuit board and connected to the optical sensor; a second electrical device, attached to the second printed circuit board and connected to the light source; a casing joined to the first and second printed circuit boards; and an electrical connector. The first printed circuit board has a through cut; and the electrical connector is arranged in the cut so as to be connected simultaneously to the first and second electrical devices.

### TECHNICAL FIELD

The present invention relates to a monitoring camera, of the type comprising: an optical sensor; a light source; a first and a second printed circuit board, attached respectively to the optical sensor and to the light source; a first electrical device, attached to the first printed circuit board and electrically connected to the optical sensor; a second electrical device, attached to the second printed circuit board and electrically connected to the light source; a casing joined to the first and second printed circuit boards; and an electrical connector; the first and second printed circuit boards being arranged substantially parallel to each other and substantially opposite each other; and being separated by a non-zero distance.

### SUMMARY

The invention is particularly applicable to monitoring cameras for motor vehicles. Such a camera is described in document U.S. Pat. No. 9,628,680.

Such cameras are, for example, mounted in the passenger compartment of a motor vehicle, to be incorporated into a system for monitoring the driver and/or occupant(s) of said vehicle.

The layout of the various components of such a camera must take into account the limited space available. Furthermore, the operation of the optical sensor can be impaired by the heat emitted by the various camera components, such as the light source.

One aim of the present invention is to provide an improved layout for monitoring cameras of motor vehicles while maintaining good thermal dissipation of the heat generated by the operation of the camera.

To this end, the invention relates to a monitoring camera of the aforementioned type, wherein: the first printed circuit board has a through cut; and the electrical connector is arranged in said cut so as to be connected simultaneously to the first and second electrical devices.

According to other advantageous aspects of the invention, the monitoring camera comprises one or more of the following features, taken individually or in all technically possible combinations:
the electrical connector comprises a first and a second connection element; the first connection element is connected to the first electrical device; and the second connection element is arranged in the through cut and connected to the second electrical device;
the through cut has an open contour on one edge of the first printed circuit board;
the first printed circuit board comprises two tabs arranged on either side of the through cut, at least one of said two tabs comprising a heat dissipation coating;
the casing comprises an intermediate element arranged between the first and second printed circuit boards, so as to maintain a non-zero distance between said first and second printed circuit boards;
the casing further comprises a first end element connected to the intermediate element, said first end element comprising a frame and a bottom, the frame comprising an indentation receiving the edge of the first printed circuit board, the bottom comprising an opening arranged opposite the cut of said first printed circuit board;
the casing further comprises a second end element, the intermediate element being arranged between the first and second end elements;
the second end element comprises a partition made of a material capable of blocking visible light and allowing infrared light to pass through, said partition facing the optical sensor and the light source.

The invention further relates to a method for assembling a monitoring camera as described above, comprising the following steps: joining the first printed circuit board with the first end element, the edge of said first printed circuit board being accommodated in the indentation of said first end element; then joining the intermediate element with the first end element; then joining the second printed circuit board with the intermediate element; then inserting the connector into the opening in the bottom of the first end element and simultaneously connecting the first and second connection elements, respectively with the first and second electrical devices.

According to an advantageous aspect of the invention, the method further comprises a step of assembling the second end element to the intermediate element, prior to the step of inserting the connector into the opening.

The invention further relates to a vehicle equipped with a monitoring camera as described above.

### BRIEF DESCRIPTION OF THE DRAWINGS

The invention will become clearer on reading the following description, given solely by way of non-limiting example, and made with reference to the drawings, wherein:

FIG. 1 is a perspective view of a monitoring camera according to one embodiment of the invention;

FIG. 2 is an exploded view of the monitoring camera shown in FIG. 1, and

FIGS. 3 and 4 are detail views of the monitoring camera shown in FIGS. 1 and 2.

### DETAILED DESCRIPTION

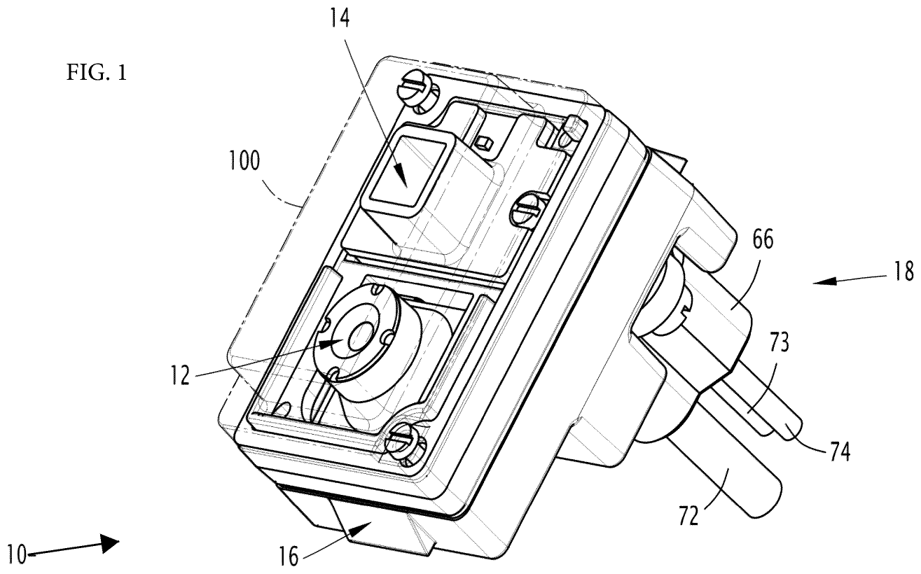

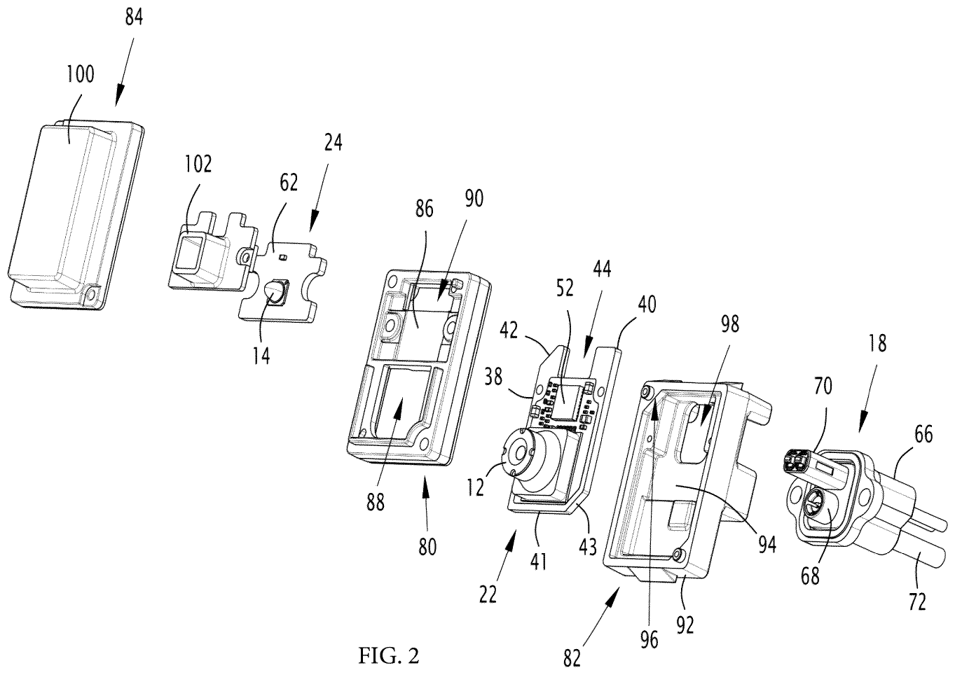

FIGS. 1 and 2 show a monitoring camera 10 according to one embodiment of the invention.

As shown in FIG. 1, the camera 10 comprises: an optical lens 12; a light source 14; a casing 16; and an electrical connector 18.

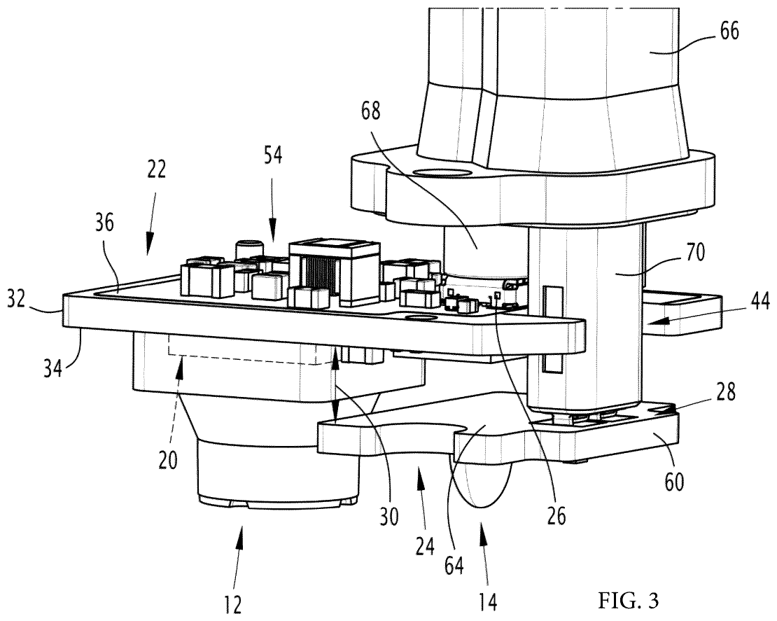

The optical lens 12 comprises an optical sensor 20, shown dotted in FIG. 3. The term “optical sensor” refers to one or more optical sensors that generate electrical/electronic signals as a function of the light images captured by the optical lens 12.

Preferably, the light source 14 comprises one or more light-emitting diodes, more preferably one or more infrared light-emitting diodes (LEDs). In the embodiment shown, the light source 14 comprises an infrared LED.

As shown in FIGS. 2 and 3, the camera 10 further comprises: first 22 and second 24 printed circuit boards; and first 26 and second 28 electrical devices.

The first 22 and second 24 printed circuit boards are attached to the optical sensor 20 and light source 14, respectively. In the embodiment shown, the first printed circuit board 22 is attached to the optical lens 12. The first 22 and second 24 printed circuit boards will be described in more detail below.

The first electrical device 26 is attached to the first printed circuit board 22 and electrically connected to the optical sensor 20. The second electrical device 28 is attached to the second printed circuit board 24 and electrically connected to the light source 14. The first 26 and second 28 electrical devices will be described in more detail below

The casing 16 is joined to the first 22 and second 24 printed circuit boards, so that said first and second printed circuit boards are arranged substantially parallel to each other and substantially facing each other. “Substantially facing each other” is intended to mean that a projection of one of the printed circuit boards 22, 24, perpendicular to said circuit, at least partially overlaps the other of said printed circuit boards. This arrangement of the two printed circuit boards reduces the size of the casing 16, making the monitoring camera 10 more compact.

The printed circuit boards 22, 24 are separated by a non-zero distance 30, as shown in FIG. 3. The distance 30 is chosen to prevent the heat generated by the light source 14 from interfering with the operation of the optical sensor 20.

The casing 16 will be described in greater detail below.

The first circuit board 22 will now be described. The first printed circuit board 22 comprises a first substrate 32, said first substrate comprising first 34 and a second 36 faces, opposite one another and substantially flat.

The optical lens 12 is attached to the first face 34 of the first substrate 32. In particular, the optical sensor 20 is attached to the first face 34 of the first substrate 32. The first electrical device 26 is attached to the second face 36 of the first substrate 32.

The first substrate 32 can have different geometric shapes, for example, circular, rectilinear, etc. Preferably, the first substrate 32 is delimited by substantially rectilinear edges. In particular, the first substrate 32 has two longitudinal edges 38, opposite and substantially parallel to each other, and first 40 and second 41 transverse edges. The first 40 and second 41 transverse edges are substantially parallel to each other and substantially perpendicular to the longitudinal edges 38

Preferably, the first substrate 32 further comprises two opposing oblique edges 42, 43, each oblique edge joining the end of one of the first 40 and second 41 transverse edges with one of the longitudinal edges 38.

The first substrate 32 has a through cut 44, which connects the first 34 and second 36 faces. In the embodiment shown, the cut 44 is formed in the first transverse edge 40 and has an open, substantially U-shaped contour 46. The first electrical device 26 is attached close to said contour 46 of the cut 44.

More specifically, in the embodiment shown, the first substrate 32 has two tabs 48, 50 extending to the first transverse edge 40, on either side of the cut 44.

The first printed circuit board 22 also includes electronic components 52, 54 attached to the first 34 and/or second 36 face of the first substrate 32. In particular, in the embodiment shown, the first printed circuit board 22 includes a processor 52, attached to the first face 34, close to the contour 46 of the cut 44.

In the embodiment shown, the first printed circuit board 22 also features a heat dissipation coating 56, partially covering the first 34 and/or second 36 face of the first substrate 32. In particular, in the embodiment shown, the heat dissipation coating 56 is arranged on at least one of the tabs 48, 50 of the first substrate 32. Preferably, the heat dissipation coating 56 is also arranged close to the longitudinal edges 38 and the second transverse edge 41.

The second circuit board 24 will now be described. The second printed circuit board 24 comprises a second substrate 60, said second substrate comprising first 62 and a second 64 faces, opposite one another and substantially flat.

The light source 14 is attached to the first face 62 of the second substrate 60. The second electrical device 28 is attached to the second face 64 of the second substrate 60.

The first face 34 of the first substrate 32 and the second face 64 of the second substrate 60 are arranged opposite each other and define the non-zero distance 30 between the first 22 and second 24 printed circuit boards.

As will be explained below, the second electrical device 28 is arranged opposite the cut 44 in the first substrate 32.

The electrical connector 18 will now be described.

The electrical connector 18 is configured for simultaneous connection to the first 26 and second 28 electrical devices. In particular, the electrical connector 18 is arranged in the cut 44 of the first substrate, so as to be connected simultaneously to the first 26 and second 28 electrical devices.

In the embodiment shown, the electrical connector 18 comprises: a body 66; and first 68 and second 70 connection elements. Preferably, the electrical connector 18 further comprises at least a first 72 and a second 73, 74 electrical cable.

The body 66 is made of an electrically insulating material such as plastic.

The body 66 extends along a connection axis 76, between the opposing first and second ends.

Each of the first 68 and second 70 connection elements projects from the first end of the body 66 along the connection axis 76. The first 68 and second 70 connection elements are spaced apart perpendicularly to the connection axis 76.

The first connection element 68 and the first electrical device 26 can be joined by translation along the connection axis 76 and perpendicular to the second face 36 of the first substrate 32. Likewise, the second connection element 70 and the second electrical device 28 can be joined by translation along the connection axis 76 and perpendicular to the second face 64 of the second substrate 60.

Along the connection axis 76, a length of the second connection element 70 is greater than a length of the first connection element 68. Said lengths of connection elements 68, 70 are configured as a function of the distance 30 between the first 22 and second 24 printed circuit boards, so as to ensure simultaneous connection between the first connection element 68 and the first electrical device 26, and between the second connection element 70 and the second electrical device 28. The second connection element 70 is then received in the cut 44 in the first substrate 32, as shown in FIG. 3.

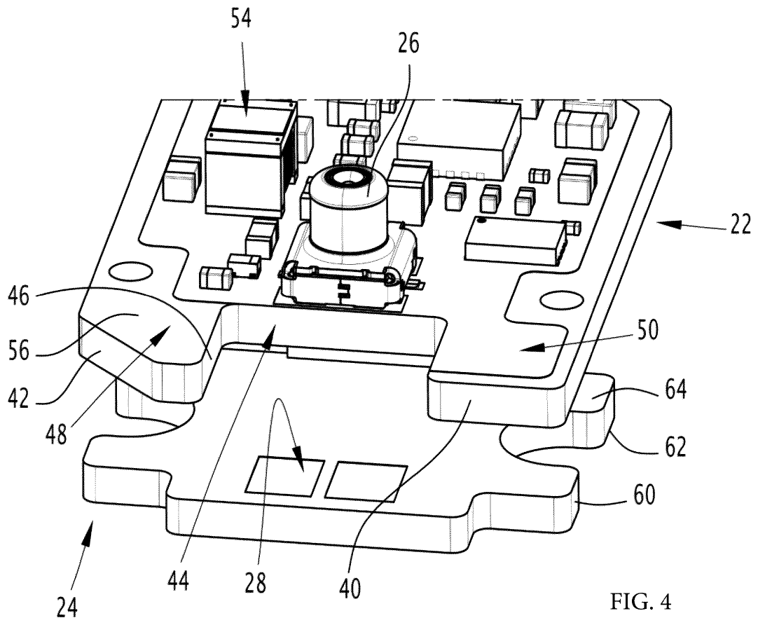

The casing 16, not shown in FIGS. 3 and 4, will now be described.

In the embodiment shown, the casing 16 is made up of various assembled components. In particular, in the embodiment shown, the casing 16 comprises: an intermediate member 80; and first 82 and second 84 end elements.

The intermediate element 80 is arranged between the first 22 and second 24 printed circuit boards, so as to maintain the non-zero distance 30 between said first and second printed circuit boards.

In the embodiment shown, the intermediate element 80 comprises in particular a plate 86 arranged substantially parallel to the first 32 and second 60 substrates, between said substrates. In the embodiment shown, the intermediate element 80 also comprises a first opening 88, configured to accommodate the optical lens 12, and a second opening 90 arranged opposite the cut 44 in the first substrate 32. The first 88 and second 90 openings are arranged on either side of the plate 86.

The first end element 82 is connected to the intermediate element 80, with the first printed circuit board 22 arranged between said intermediate element 80 and said first end element 82.

The first end element 82 comprises a frame 92 and a bottom 94. The frame comprises an indentation 96 shaped to complement the edges 38, 40, 41, 42, 43 of the first printed circuit board 22.

The bottom 94 of the first end element 82 comprises a third opening 98 opposite the cut 44 of the first printed circuit board 22.

The second end element 84 is connected to the intermediate element 80, with the second printed circuit board 24 arranged between said intermediate element 80 and said second end element 84.

The second end element 84 comprises a partition 100 made of a material capable of blocking visible light and allowing infrared light to pass through. Said partition 100 is positioned opposite the optical lens 12 and the light source 14.

In the embodiment shown, the camera 10 further comprises a light deflector 102, arranged around the light source 14, between the partition 100 and the second printed circuit board 24. Preferably, the light deflector 102 is attached to the second printed circuit board 24.

A method for mounting the monitoring camera 10, will now be described.

The first printed circuit board 22 is joined to the first end element 82 of the casing 16. During this joining, the edges 38, 40, 41, 42, 43 of the first printed circuit board 22 are received in the indentation 96 of the first end element. In particular, the shape of the indentation 96, matching the oblique edges 42, 43, enables the faces 34, 36 of the first substrate 32 to be correctly oriented with respect to the first end element 82.

Next, the intermediate element 80 is joined to the first end element 82 and the first printed circuit board 22, with the optical lens 12 fitting into the first opening 88 of said intermediate element 80.

The second printed circuit board 24 is then joined to the intermediate element 80, with the plate 86 of said intermediate element interposed between the first 22 and second 24 printed circuit boards. The light source 14, carried by the second printed circuit board 24, is oriented away from said plate 86.

The second end element 84 is then connected to the intermediate element 80, so that the partition 100 faces the optical lens 12 and the light source 14.

The connector 18 is then inserted into the third opening 98 in the bottom 94 of the first end element 82, by translation along the connection axis 76 and perpendicular to the first 22 and second 24 printed circuit boards. This introduction allows the second connection element 70 to pass through the cut 44 of the first printed circuit board 22 and the second opening 90 of the intermediate element 80. This results in the simultaneous connection of the first 68 and second 70 connection elements of the connector 18, respectively with the first 26 and second 28 electrical devices.

The monitoring camera 10 described above is thus obtained.

During the operation of the camera, the tabs 48, 50 of the first substrate 32, at least partially covered by a heat dissipation coating 56, dissipate the operating heat of the camera. In particular, the operating heat of the processor 52, located close to the cut 44 and the tabs 48, 50, is dissipated in this way.

1. A monitoring camera, comprising: an optical sensor; a light source; first and second printed circuit boards attached to the optical sensor and the light source respectively; a first electrical device, attached to the first printed circuit board and electrically connected to the optical sensor; a second electrical device, attached to the second printed circuit board and electrically connected to the light source; a casing joined to the first and second printed circuit boards; and an electrical connector;
the first and second printed circuit boards being arranged substantially parallel to each other and substantially opposite each other; and being separated by a non-zero distance;
wherein the first printed circuit board has a through cut; and the electrical connector is arranged in said cut so as to be connected simultaneously to the first and second electrical devices.

2. The monitoring camera according to claim 1, wherein: the electrical connector comprises first and second connection elements; the first connection element is connected to the first electrical device; and the second connection element is disposed in the through cut and connected to the second electrical device.

3. The monitoring camera according to claim 1, wherein the through cut has a contour open on one edge of the first printed circuit board.

4. The monitoring camera according to claim 3, wherein the first printed circuit board comprises two tabs arranged on either side of the through cut, at least one of said two tabs comprising a heat dissipation coating.

5. The monitoring camera according to claim 1, wherein the casing comprises an intermediate element arranged between the first and second printed circuit boards, so as to maintain the non-zero distance between said first and second printed circuit boards.

6. The monitoring camera according to claim 5, wherein the through cut has a contour open on one edge of the first printed circuit board, and wherein the casing further comprises a first end element joined to the intermediate member, said first end element comprising a frame and a bottom, the frame comprising an indentation receiving the edge of the first printed circuit board, the bottom comprising an opening disposed opposite the cut of said first printed circuit board.

7. The monitoring camera according to claim 6, wherein the casing further comprises a second end element, the intermediate member being arranged between the first and second end elements.

8. The monitoring camera according to claim 7, wherein the second end element comprises a partition made of a material capable of blocking visible light and allowing infrared light to pass through, said partition facing the optical sensor and the light source.

9. A method for mounting a monitoring camera according to claim 6, comprising the following steps: joining the first printed circuit board with the first end element, the edge of said first printed circuit board being accommodated in the indentation of said first end element; then joining the intermediate element with the first end element; then joining the second printed circuit board with the intermediate element; then inserting the connector into the opening in the bottom of the first end element and simultaneously connecting the first and second connection elements, respectively, with the first and second electrical devices.

10. The mounting method according to claim 9, wherein the casing further comprises a second end element, the intermediate member being arranged between the first and second end elements, the method further comprising a step of joining the second end element to the intermediate element, prior to the step of inserting the connector into the opening.
